(19) United States
(12) Patent Application Publication
(10) Pub. No.: US 2012/0323648 A1
(43) Pub. Date: Dec. 20, 2012

(54) Article, System, and Method for Actuated Advertising

(76) Inventor: David Dardashti, Miami, FL (US)

(21) Appl. No.: 13/310,857

(22) Filed: Dec. 5, 2011

Related U.S. Application Data
(60) Provisional application No. 61/457,080, filed on Dec. 21, 2010.

(51) Int. Cl. G06Q 30/02; G01S 13/02

(52) U.S. Cl. 705/14.4; 342/176

(57) ABSTRACT

A system for providing a customized display having a GPS signal transmitter; a GPS receiver/locator; a microprocessor having a display control parameters stored theron; an actuator; and a a display and an advertising method is performed using the system.

### INDEX TO RELATED APPLICATIONS

This application claims benefit of U.S. Provisional Patent Application No. 61/457,080 filed Dec. 21, 2010 the disclosure of which is incorporated herein by reference in its entirety.

### SUMMARY OF THE INVENTION

In one embodiment, the present invention is a system for providing a customized display comprising:
a GPS signal transmitter;
a GPS receiver/locator;
a microprocessor having a display control parameters stored theron;
an actuator; and a
a display.

The system has an actuator that is a manual switch, an optical actuator, or combinations thereof.

A microprocessor selects display output based on GPS location information and the display is words, pictures, logos, or combinations thereof.

The system microprocessor selects display output based on GPS location information, time of day, date, or combinations thereof.

The present invention also includes a method of selling advertising comprising the steps of:
providing a system of the present invention;
selling advertisements based on location, day, time, date, or combinations thereof;
   configuring the system to display particular ads upon system activation based on said, location, day, time, date, or combinations thereof;
   displaying configured ads when the system is actuated at a particular location, day, time, date, or combinations thereof.

### BRIEF DESCRIPTION OF THE SEVERAL VIEWS OF THE DRAWINGS

FIG. 1 is a side view of an automobile using the system and device of the resent invention.

FIG. 2 is a rear view of an automobile using the system and device of the resent invention.

FIG. 3 is a process schematic of the present invention.

FIG. 4 is an embodiment of the present invention used in concert with a room.

FIG. 5 is an embodiment of the present invention using a text message.

FIG. 6 is an embodiment of the present invention using an image message.

FIG. 7 is an embodiment of the present invention using a logo as a message.

FIG. 8 is an embodiment of the present invention using a LED display as a message.

FIG. 9 is an embodiment of the present invention using a message displayed in a restroom.

FIG. 10 is process schematic using an actuator, wherein the actuator is an electronic optical switch.

### DETAILED DESCRIPTION OF THE PREFERRED EMBODIMENT

The present invention relates to an article, system, and method for displaying an advertisement when actuated event occurs.

In one embodiment of the present invention, as seen in FIG. 2, a display 10 viewable from the rear portion 13 of a motor vehicle is provided. When the driver of said motor vehicle applies the brake, brake light 11 illuminate. In addition to illuminating brake lights 11, the display 10 is activated. It contemplated, in one embodiment, that the actuation of the display is directly wired to the brake light mooring system of a motor vehicle.

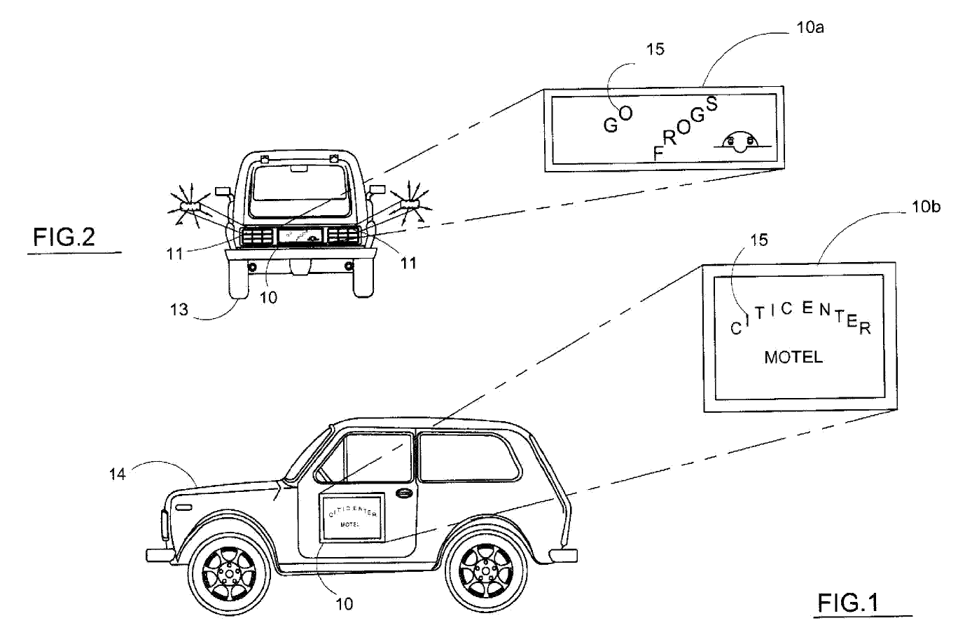

In an embodiment as seen in FIG. 1, display 10 is viewable from the long side 14 of a vehicle.

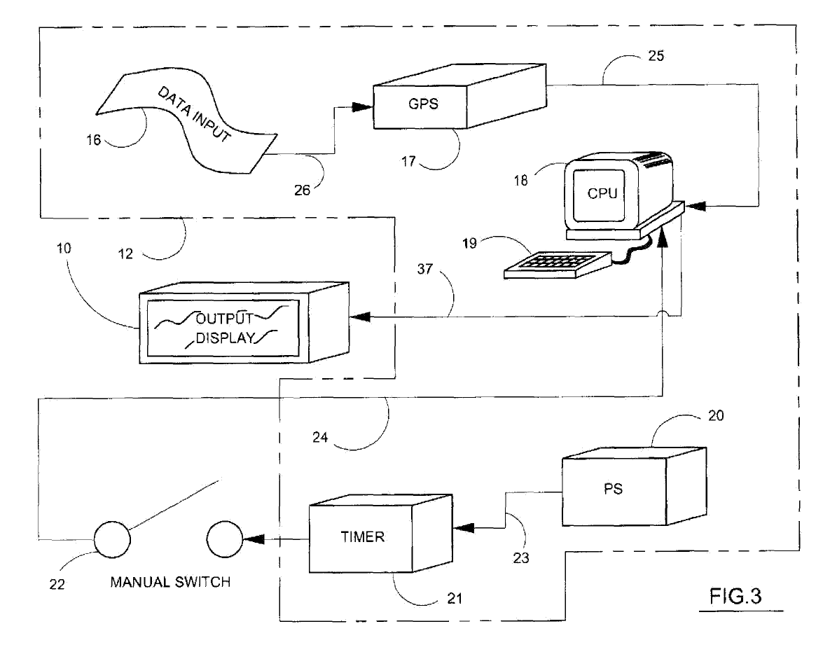

In one embodiment of the present invention, as set forth in the schematic of FIG. 3, a data input 16 is operatively connected by communications link 26 to global positioning satellite (GPS) system 17. The input is any acceptable electronic data input device that communicates location information to GPS system 17. The communications link is any of hard wire, telephone transmission, SMS, MMS, Internet transmission, and combinations thereof.

A user controls setting on the system though any computer interface including, but not limited to a keyboard 19 and computer processing unit (CPU) 18.

As depicted on the upper portion of the schematic, input 16 transmits location information along communications link 26 to GPS system 17. System 17 communicates along system control communications link 25 to CPU 18. CPU 18 receives location information from input 16 and transmits a message along message communications link 37 to display 10. In this embodiment, display 10 is customizable based on the location of data input 16.

By way of example, if a person is in an auto at 100 Main St and presses the brake pedal of a car, the rear or side display 10 displays an advertisement for Joe's Diner at 140 Main St. Persons behind, or to the side of the vehicle will view the ad customizes for the particular location. The present invention also contemplates the advertising method whereby business will purchase advertising that is transmitted only when vehicles are in a pre-determined proximity to the establishment. Additionally, as depicted on the lower portion of FIG. 3, a manual switch 22 is operatively associated with a power supply 20 and optionally a timer 21. Timer 21 is connected to power supply 20 through connection 23. In this embodiment, a person entering a door, of a hotel room or other venue, will actuate the system and produce a display on display 10 based on the location of manual switch 22.

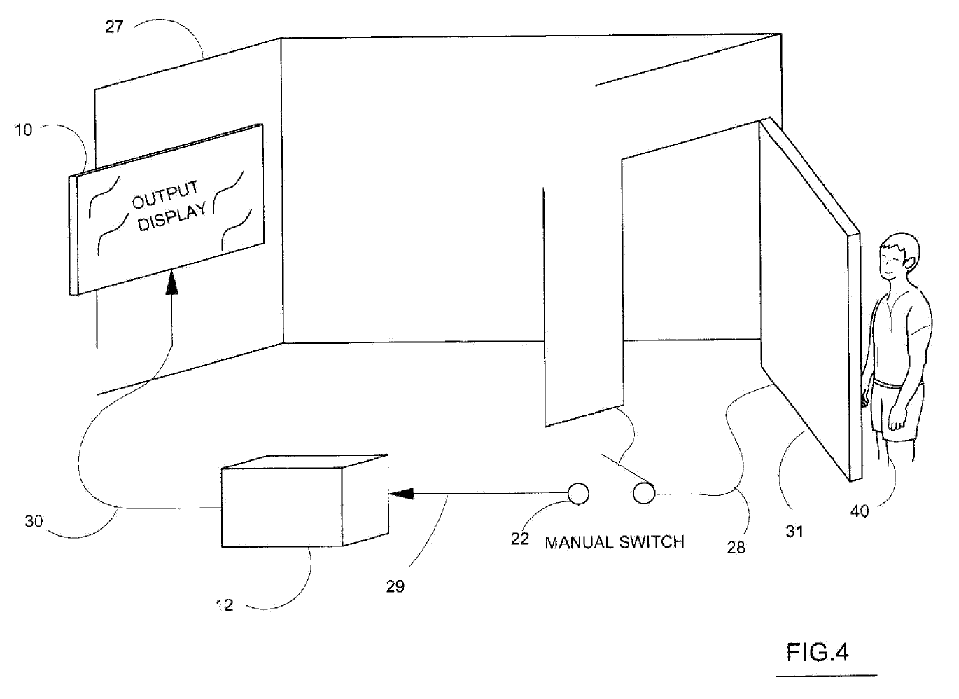

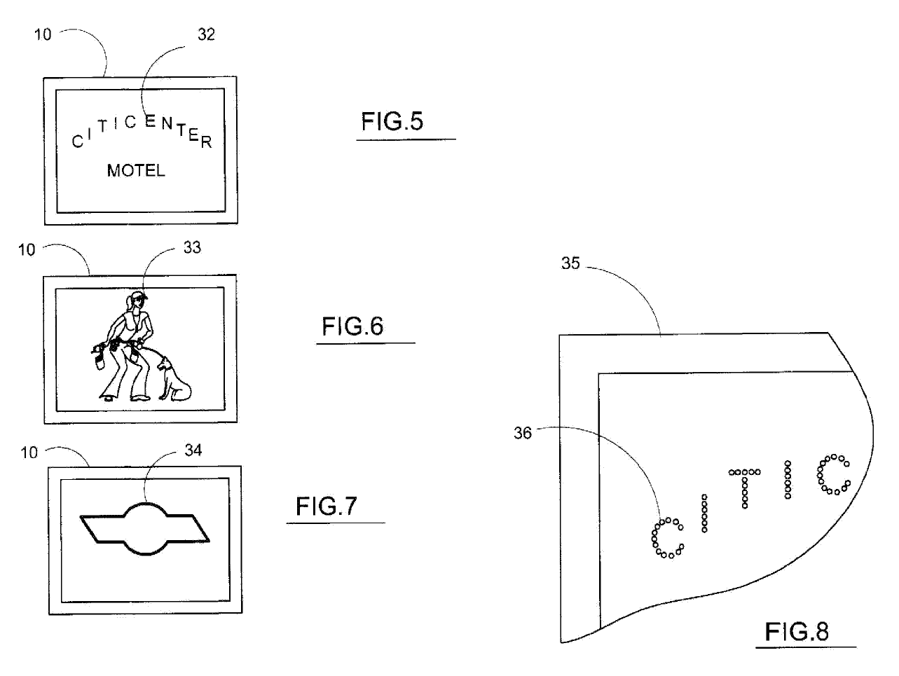

As depicted in FIG. 4 a person 40 opens door 31 and actuates manual switch 22 through manual switch door connection 28. This actuation is registered in a processing unit 12, which is operatively connected to display 10 in room 27 though communications link 30. In this embodiment, for example, a person enters a hotel room at 6 pm and a local restaurant open until 10 pm has paid for a display ad that appears on display 10. In another embodiment, person 40 enters room 27 at 2 am, and an all night pizza delivery store has paid for ads that are actuated from midnight to 6 am. These examples are illustrative only and do not limit the use and scope of the invention.

In one embodiment, the system can project a logo such as shown in FIG. 7. When a car operator presses the brake pedal, instead of a generic red light displayed in the rear window brake light display, an automaker's logo, such as the “Chevy” logo of FIG. 7 is displayed.

The displays can be any visual display and include, but are not limited to, pictures, words, logos, LED, LCD, and combinations thereof.

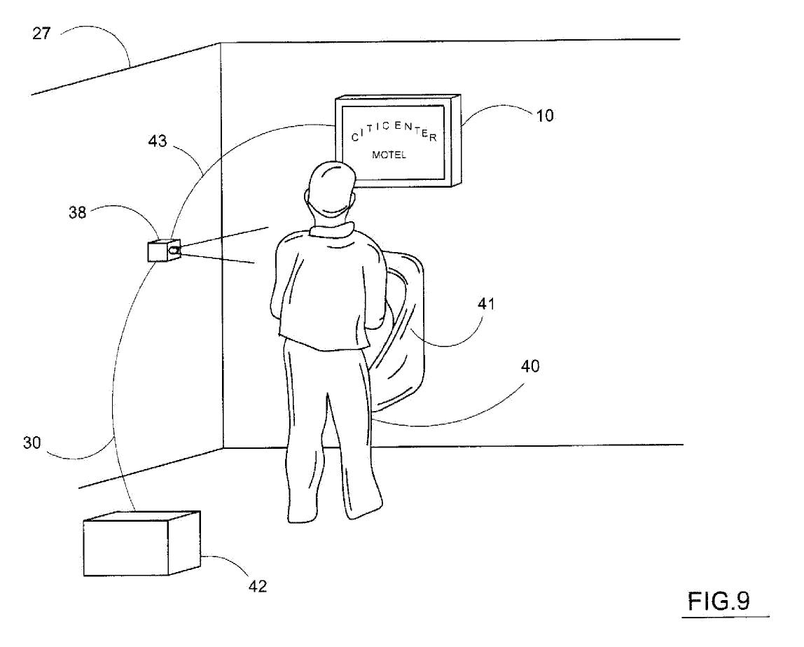

The system of the present invention can be used in restrooms and advertising is specific depending on date, time, and location, as shown in FIG. 9. As another example, a patron at a football game goes to the restroom and because the game is near conclusion, the system displays taxi or transportation contact information. In this embodiment an optical sensor 38 communicates over communication means 43 to display 10. Optical sensor 38 is connected to system processor 42 through system communications link 30. System processor 42 controls the display 10 based on date and time criteria.

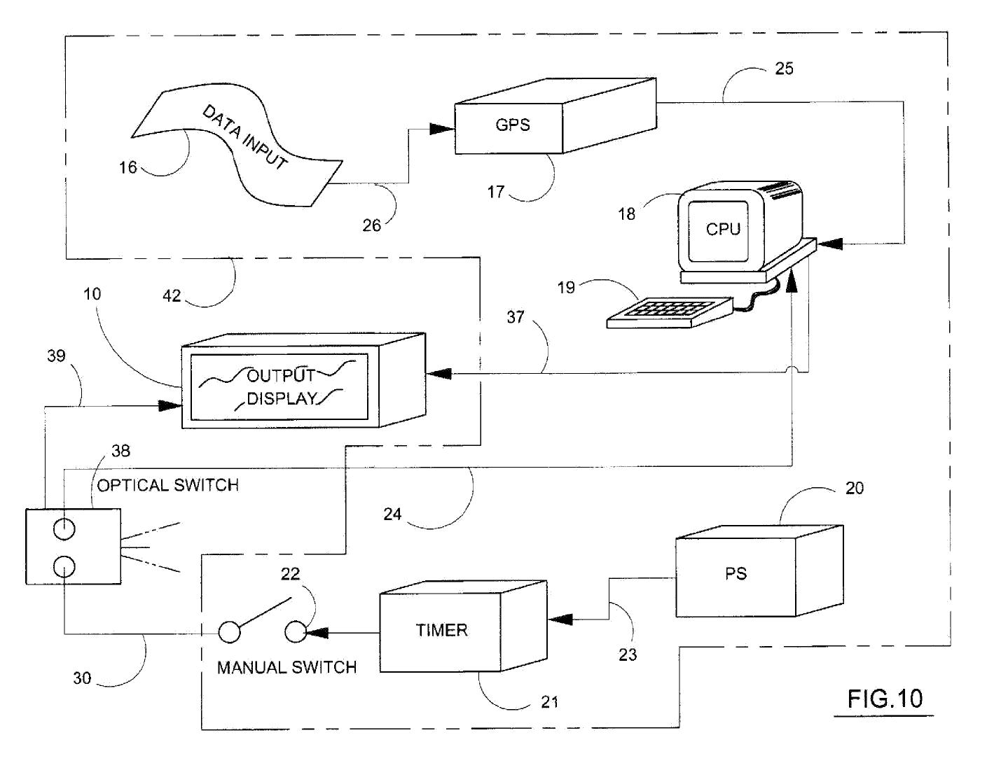

The schematic of FIG. 10 shows actuation of the system by optical actuator 38.

In another embodiment of the invention, a wireless global positioning satellite (GPS) device 17 is operatively connected to the system. The GPS 17 transmits vehicle position information to system controller 18 and provides an advertising display based on the physical location of a vehicle at the time the brake is activated. System controlled 18 is any microprocessor based controller including, but not limited to CPU, iPad, smartphone, or combinations thereof.

The present invention includes a method for selling advertising based on time and location of the display.

The particular advertiser would pay the motor vehicle owner and/or driver based on the number of times a particular advertisement was displayed in their vehicle.

In another embodiment, as related to motor vehicles and automobiles, the system is used to display messages about missing persons in a particular area, road detours/delays, and other information desired to be conveyed to persons in motor vehicles on the road.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for providing a customized display comprising:
a GPS signal transmitter;
a GPS receiver/locator;
a microprocessor having a display control parameters stored theron;
an actuator; and a
a display.

2. The system of claim 1 wherein said actuator is a manual switch, an optical actuator, or combinations thereof.

3. The system of claim 1, wherein said microprocessor selects display output based on GPS location information.

4. The system of claim 1, wherein said display is words, pictures, logos, or combinations thereof.

5. The system of claim 1, wherein said microprocessor selects display output based on GPS location information and time of day.

6. The system of claim 1, wherein said microprocessor selects display output based on GPS location information, time of day, and date.

7. A method of selling advertising comprising the steps of:
providing a system of claim 1;
selling advertisements based on location, day, time, date, or combinations thereof;
configuring the system to display particular ads upon system activation based on said, location, day, time, date, or combinations thereof;
displaying configured ads when the system is actuated at a particular location, day, time, date, or combinations thereof.
